(19) United States
(12) Patent Application Publication
(10) Pub. No.: US 2020/0325051 A1
(43) Pub. Date: Oct. 15, 2020

(54) WASTEWATER TREATMENT SYSTEM USING ANAEROBIC AMMONIUM OXIDATION IN MAINSTREAM

(71) Applicant: Foundation for Research and Business, Seoul National University of Science and Technology, Nowon-gu Seoul (KR)

(72) Inventor: Kyungik Gil, Nowon-gu Seoul (KR)

(73) Assignee: Foundation for Research and Business, Seoul National University of Science and Technology, Nowon-gu Seoul (KR)

(21) Appl. No.: 16/087,032

(22) PCT Filed: May 29, 2018
(86) PCT No.: PCT/KR2018/006070

§ 371 Date: Sep. 20, 2018

(30) Foreign Application Priority Data
May 29, 2017 (KR) 10-2017-0065939

(51) Int. Cl. C02F 3/30; C02F 11/04

(52) U.S. Cl. CPC C02F 3/307; C02F 2101/166; C02F 3/303; C02F 11/04

(57) ABSTRACT

A wastewater treatment system may use recycle water to apply an anaerobic ammonium oxidation (ANAMMOX) process to a water treatment process (mainstream treatment process) and to stably supply nitrite required for an ANAMMOX. By applying the ANAMMOX process, nitrogen and phosphorus may be simultaneously treated in the water treatment process, and recycle water may be used as a source of nitrite for ANAMMOX, thereby reducing wastewater treatment costs and pollutant loading.

### CROSS-REFERENCE TO RELATED APPLICATIONS

This application is a national phase entry under 35 U.S.C. § 371 of International Patent Application PCT/KR2018/006070, filed May 29, 2018, designating the United States of America, which claims the benefit under Article 8 of the Patent Cooperation Treaty to Korean Patent Application Serial No. 10-2017-0065939, filed May 29, 2017.

### TECHNICAL FIELD

One or more example embodiments relate to a wastewater treatment system that may use recycle water as a source of nitrite to apply an anaerobic ammonium oxidation reaction to a water treatment process (mainstream treatment process) of a municipal wastewater treatment plant.

### BACKGROUND ART

Nutrients among pollutants mainly include nitrogen discharged from sewage, livestock excretions, and the like, and phosphorus emitted from industrial products, such as, pesticides, and the like. When nutrients are mixed with rivers, eutrophication may occur, which may have a bad influence on a water system. Generally, nutrients have a large amount of nitrogen derived from wastewater. Due to nitrogen, eutrophication occurs and the content of dissolved oxygen in river decreases, and thus it is necessary to remove nitrogen. For example, ammonia nitrogen, nitrite, nitrate, and organic nitrogen may be mainly contained as nitrogen in wastewater. To remove nitrogen biologically, a wastewater treatment technology fused with an oxidation reduction technology is required.

To remove nitrogen in a municipal wastewater treatment plant (MWTP), a physicochemical method of removing nitrogen by adding chemicals, and a biological nitrogen removal process using microorganisms are mainly used. When a concentration of nitrogen contained in wastewater is low, an ion exchange method, or an oxidation method using chlorine and ozone may be used. However, in the physicochemical method, a secondary water pollution due to the added chemical agents may occur. Accordingly, recently, the biological nitrogen removal process tends to be used.

When the concentration of the nitrogen in the wastewater is high, a biological process may be efficient. As an example of the biological process, a method of oxidizing ammonia nitrogen to nitrite or nitrate by nitrifying bacteria, and of adding an electron donor, such as methanol, and the like, to reduce nitrite or nitrate into nitrogen gas by denitrifying bacteria, and of removing nitrogen from wastewater, has been known.

However, since such a method requires oxygen greater than oxidizing power required to oxidize ammonia nitrogen to nitrite or nitrate, high costs incur in terms of energy required for a wastewater treatment due to requirements of an excessive amount of oxygen to be supplied to microorganisms. Also, a cost for adding an organic matter, such as methanol, and the like, as an electron donor is required for a denitrification reaction. Since nitrifying bacteria and denitrifying bacteria that consume such an organic matter and that are multiplied become surplus sludge, a waste disposal cost issue occurs. In particular, since nitrate is in an oxidized state in comparison to nitrite, an oxygen supply cost is further increased, a larger number of electron donors are required for reduction of nitrate, and an amount of surplus sludge to be generated also increases.

Accordingly, recently, a denitrification method using autotrophic denitrifying microorganisms capable of reacting ammonia nitrogen as an electron donor with nitrite as an electron acceptor and generating nitrogen gas under an anoxic condition is being provided. Such a nitrogen removal process is called an anaerobic ammonium oxidation (ANAMMOX, hereinafter, referred to as an “ANAMMOX”), and the used autotrophic denitrifying microorganisms may be referred to as “ANAMMOX bacteria.” By a denitrification method using an ANAMMOX, energy may be reduced by oxidizing ammonia nitrogen using oxidizing power of nitrite, and it is not necessary to supply oxygen separately or to add an organic matter, such as methanol, and the like, thereby reducing costs incurred therefrom.

To smoothly perform the ANAMMOX, ammonia nitrogen and nitrite need to be stably supplied. Since it is difficult for nitrite corresponding to an intermediate stage of nitrification to exist in the form of nitrite in a natural state, a method of supplying nitrite by inhibiting activity of nitrite oxidizing bacteria through an artificial operation by an operator, or by adjusting copies of nitrite oxidizing bacteria may be used. Oxidizing of ammonia nitrogen to nitrite is referred to as a “nitritation” and the nitritation is affected by various factors, such as a pH, a concentration of ammonia nitrogen, a concentration of nitrite, a retention time, an organic matter, and the like. Since most of nitrogen in sewage flowing into a sewage treatment plant exists in the form of ammonia nitrogen, nitrite needs to be separately supplied for an ANAMMOX in a water treatment process (mainstream treatment process). A scheme of artificially injecting nitrite may be taken into consideration, but is not efficient in terms of an operation of a MWTP for a relatively long period of time, and an economic feasibility decreases.

### BRIEF SUMMARY

### Technical Subject

The present disclosure is to solve the foregoing problems, and example embodiments provide a wastewater treatment system that may use “recycle water” (wastewater generated in a sludge treatment process), to apply an ANAMMOX to a water treatment process (mainstream treatment process) and to stably supply nitrite required for the ANAMMOX.

However, the problems to be solved in the present disclosure are not limited to the foregoing problems, and other problems not mentioned herein would be clearly understood by one of ordinary skill in the art from the following description.

### Technical Solution

According to an aspect, there is provided a wastewater treatment system including an ANAMMOX reactor of a water treatment process (mainstream treatment process) into which sewage containing ammonia nitrogen flows, and a nitritation reactor for recycle water configured to oxidize ammonia nitrogen in recycle water to nitrite, wherein effluent from the nitritation reactor for recycle water flows into the ANAMMOX reactor of the water treatment process.

According to another aspect, there is provided a wastewater treatment system including a primary sedimentation basin configured to deposit sediments in response to an inflow of sewage, an anaerobic reactor configured to discharge phosphorus contained in effluent of the primary sedimentation basin, an ANAMMOX reactor configured to remove ammonia nitrogen contained in effluent of the anaerobic reactor using an ANAMMOX, and a nitritation reactor for recycle water configured to oxidize ammonia nitrogen in recycle water to nitrite, wherein effluent from the nitritation reactor for recycle water flows into the ANAMMOX reactor.

According to still another aspect, there is provided a wastewater treatment system including a primary sedimentation basin configured to deposit sediments in response to an inflow of sewage, an anaerobic reactor configured to discharge phosphorus contained in effluent of the primary sedimentation basin, a nitritation reactor configured to convert ammonia nitrogen contained in a supernatant of the primary sedimentation basin to nitrite, and the ANAMMOX reactor configured to remove ammonia nitrogen contained in effluent of the nitritation reactor.

The wastewater treatment system may further include a nitritation reactor for recycle water configured to oxidize ammonia nitrogen in recycle water to nitrite. Effluent from the nitritation reactor for recycle water may flow into the ANAMMOX reactor.

The wastewater treatment system may further include an anoxic reactor located behind the ANAMMOX reactor.

The wastewater treatment system may further include an oxic reactor located behind the anoxic reactor.

The wastewater treatment system may further include an oxic reactor for an organic matter removal process located in front of the ANAMMOX reactor.

The recycle water may include at least one wastewater selected from the group consisting of an anaerobic digestion supernatant, a sludge thickener supernatant and a decanted water, or a combination thereof.

A sludge reduction technology may be applied to the recycle water.

The recycle water may include at least one and more wastewater selected from the group consisting of sewage flowing into a MWTP, a waste liquid of a sludge process in the MWTP, a leachate, livestock wastewater excretions and excreta, or a combination thereof.

### Effect of the Invention

According to example embodiments, a wastewater treatment system may be eco-friendly and economic, and may simultaneously treat nitrogen and phosphorous by applying an ANAMMOX method to a water treatment process.

Also, according to example embodiments, it is possible to reduce a wastewater treatment cost and pollutant loading of a water treatment process using recycle water as a source of nitrite flowing into an ANAMMOX reactor.

### BRIEF DESCRIPTION OF THE DRAWINGS

FIG. 1 is a diagram illustrating an example of a configuration of a wastewater treatment system according to an example embodiment.

FIG. 2 is a diagram illustrating another example of a configuration of a wastewater treatment system according to an example embodiment.

FIG. 3 is a diagram illustrating an example of a configuration of a wastewater treatment system that further includes an oxic reactor located in front of an ANAMMOX reactor according to an example embodiment.

FIG. 4 is a diagram illustrating an example of a configuration of a wastewater treatment system that further includes a nitritation reactor to convert ammonia nitrogen contained in a supernatant of a primary sedimentation basin to nitrite and use the nitrite according to an example embodiment.

FIG. 5 is a diagram illustrating an example of a configuration of the wastewater treatment system of FIG. 1 that further includes a nitritation reactor.

FIG. 6 is a diagram illustrating another example of a configuration of a wastewater treatment system according to an example embodiment.

### DETAILED DESCRIPTION

Hereinafter, example embodiments of the present disclosure will be described in detail with reference to the accompanying drawings.

Various modifications may be made to the example embodiments. The example embodiments are not construed as limited to the disclosure and should be understood to include all changes, equivalents, and replacements within the idea and the technical scope of the disclosure.

The terminology used herein is for the purpose of describing particular example embodiments only and is not intended to be limiting of example embodiments. As used herein, the singular forms are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

Regarding the reference numerals assigned to components in the drawings, it should be noted that the same components will be designated by the same reference numerals, wherever possible, even though they are shown in different drawings. Also, in describing of example embodiments, detailed description of well-known related structures or functions will be omitted when it is deemed that such description will cause ambiguous interpretation of the present disclosure.

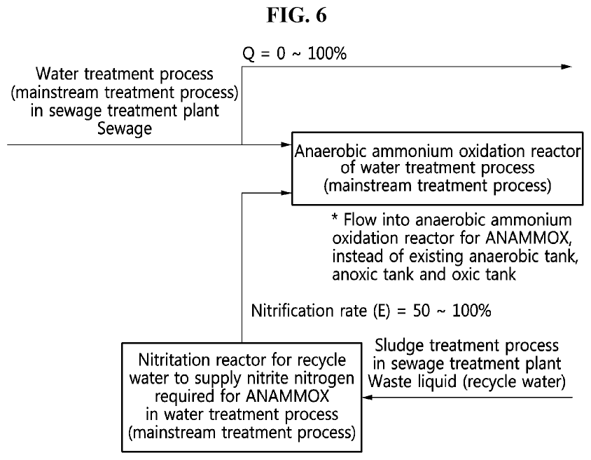

An example embodiment provides a wastewater treatment system that includes an ANAMMOX reactor 102 of a water treatment process (mainstream treatment process) into which sewage containing ammonia nitrogen flows, and a nitritation reactor 200 for recycle water configured to oxidize ammonia nitrogen in wastewater generated in a sludge treatment process to nitrite. Recycle water flowing out from the nitritation reactor for recycle water may flow into the ANAMMOX reactor of the water treatment process (mainstream treatment process), as shown in FIG. 6.

In the present disclosure, the water treatment process (mainstream treatment process) refers to a combination of various treatment facilities, for example, a primary sedimentation basin, a bioreactor, a secondary sedimentation basin, and the like, and an arrangement and a combination of treatment facilities are determined based on various situations of a MWTP. The water treatment process is distinguished from a sludge treatment process (side stream process) of a wastewater treatment process.

The term “anaerobic ammonium oxidation (ANAMMOX)” used herein refers to a reaction of oxidizing ammonium using ammonia nitrogen as an electron donor and using nitrite as an electron acceptor and of converting ammonium to nitrogen gas under an anaerobic condition.

In the anaerobic ammonium oxidation reactor 102, an ANAMMOX by ANAMMOX bacteria may be performed. The ANAMMOX bacteria used in the ANAMMOX may include, for example, Candidatus Brocadia sinica, Kuenenia spp, Brocadia anammoxidans, Kuenenia stuttgartiensis, and Candidatus Jettenia caeni. Due to characteristics of slowly growing ANAMMOX bacteria, a relatively long solid retention time (SRT) may desirably be maintained so that ANAMMOX bacteria may remain in a reactor for a long period of time. A hydraulic retention time (HRT) may be manipulated as a short HRT for an increase in a nitrogen load. The HRT may range from 0.06 d to 11 d, but there is no limitation thereto. A ratio of ammonia nitrogen and nitrite required for the ANAMMOX may be, but is not limited to, 1:1.32 based on Expression 1 shown below, and may desirably range from 1:0.5 to 1:1.5. Desirably, a pH of the anaerobic ANAMMOX reactor may range from 6.7 to 8, an alkalinity/ammonium nitrogen ratio may be less than or equal to 8. Also, since ANAMMOX bacteria are anaerobic bacteria, a concentration of dissolved oxygen (DO) may desirably be maintained at 0.06 mg/L or less.

NH₄+1.32NO₂⁺0.66 HCO₃⁻+0.13H⁺->0.55CH₂O_{0.5}N_{0.15}+1.02N₂+0.26NO₃⁻+2.03H₂O [Expression 1]

Another example embodiment provides a wastewater treatment system that includes a primary sedimentation basin 100 configured to deposit sediments in response to an inflow of sewage, an anaerobic reactor 101 configured to discharge phosphorus contained in effluent of the primary sedimentation basin, an ANAMMOX reactor 102 configured to remove ammonia nitrogen contained in effluent of the anaerobic reactor using an ANAMMOX, and a nitritation reactor 200 for recycle water configured to oxidize ammonia nitrogen in recycle water to nitrite. Effluent from the nitritation reactor for recycle water may flow into the ANAMMOX reactor 102.

In the wastewater treatment system, an anaerobic reactor may be located in front of an ANAMMOX reactor. When mixed liquor suspended solids (MLSS) in the anaerobic reactor flow into the ANAMMOX reactor, ANAMMOX bacteria may be likely to be affected by the MLSS. Thus, when the MLSS of the anaerobic reactor have an influence on an efficiency of the ANAMMOX reactor and securing of ANAMMOX bacteria, the anaerobic reactor may be excluded, and a location to which sludge returns may be changed.

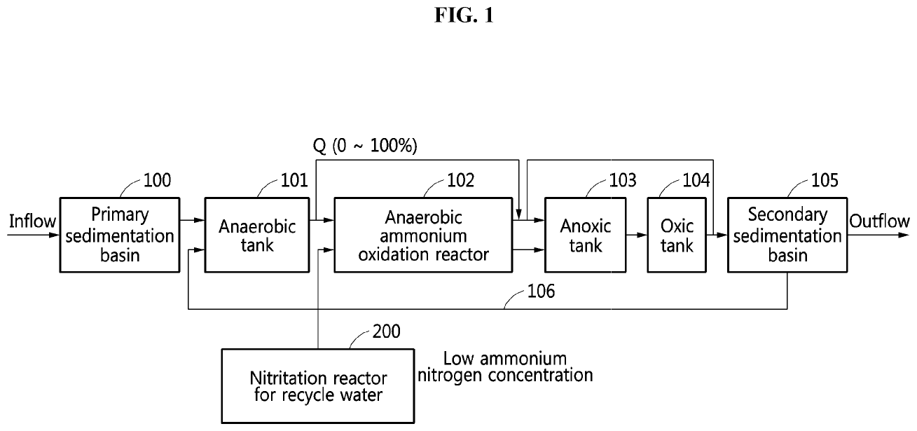

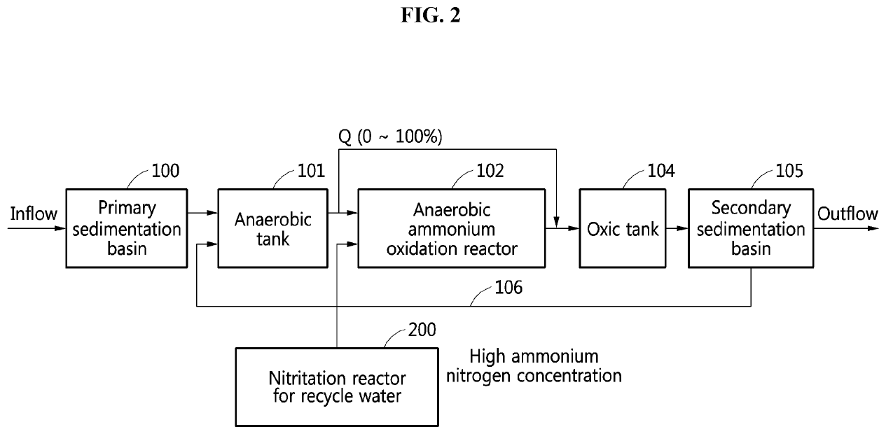

In the wastewater treatment system, the following two examples are provided based on a concentration of nitrite contained in recycle water flowing into the nitritation reactor for recycle water. FIG. 1 shows Example 1 in which a load of ammonia nitrogen contained in influent sewage is greater than a load of nitrite that may be supplied through a nitritation reaction of recycle water. FIG. 2 shows Example 2 in which a load of nitrite that may be supplied through a nitritation of recycle water is greater than a load of ammonia nitrogen contained in influent sewage.

Referring to FIG. 1, when it is impossible to sufficiently supply nitrite for an ANAMMOX because a concentration of nitrite contained in recycle water is less than a concentration of ammonia nitrogen contained in influent sewage, a flow rate from the anaerobic reactor 101 to the ANAMMOX reactor 102 may be adjusted based on the concentration of the nitrite generated by the nitritation of the recycle water. Thus, an effluent of the anaerobic reactor including ammonia nitrogen that may not be removed through the ANAMMOX may flow into an anoxic reactor 103 by adjusted amount of quantity. Ammonia nitrogen remaining in the effluent of the anaerobic reactor may be additionally removed through nitrification—denitrification by passing through the anoxic reactor 103 and an oxic reactor 104. Nitrite generated by the ANAMMOX may also be reduced to nitrogen by passing through the anoxic reactor 103 and the oxic reactor 104. In the oxic reactor 104, organic matters remaining in the sewage may be additionally removed.

Referring to FIG. 2, when the concentration of the nitrite in the recycle water is greater than the concentration of the ammonia nitrogen in the influent sewage, an anoxic reactor may not exist, and an oxic reactor 104 configured to remove organic matters remaining in the sewage may be located behind an anaerobic ammonium oxidation reactor 102 unlike FIG. 1. Since a sufficient amount of nitrite is contained in the recycle water to perform an ANAMMOX with the ammonia nitrogen in the influent sewage, a flow rate into the ANAMMOX reactor 102 may be selectively adjusted.

Sewage flowing into a secondary sedimentation basin 105 through the oxic reactor 104 may return to the anaerobic reactor 101 through a return line 106, and thus it is possible to additionally remove phosphorus by a luxury uptake.

Still another example embodiment provides a wastewater treatment system that includes a primary sedimentation basin 100 configured to deposit sediments in response to an inflow of sewage, an anaerobic reactor 101 configured to discharge phosphorus contained in effluent of the primary sedimentation basin, a nitritation reactor 108 configured to convert ammonia nitrogen contained in a supernatant of the primary sedimentation basin to nitrite, and an ANAMMOX reactor 102 configured to remove ammonia nitrogen contained in effluent of the nitritation reactor.

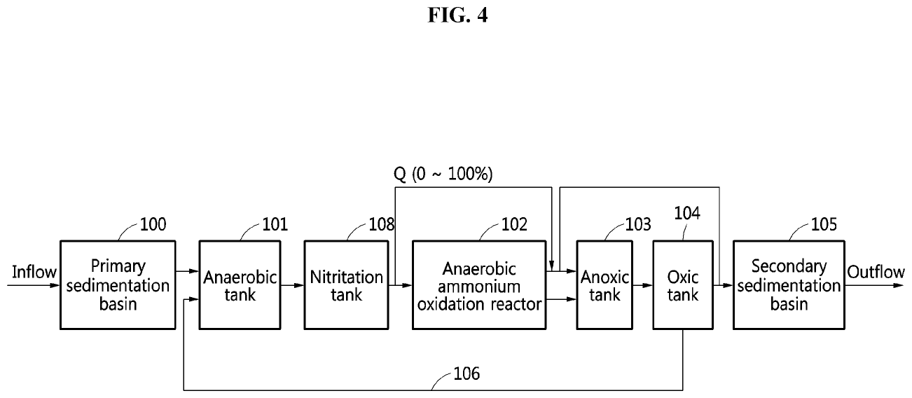

In a wastewater treatment system of FIG. 4, a nitritation may be applied directly to influent sewage, effluent of a primary sedimentation basin, a mixed solution of the influent sewage and a recycle water, and a mixed solution of the effluent of the primary sedimentation basin and the recycle water. Thus, ammonia nitrogen contained in a supernatant of the primary sedimentation basin may be converted to nitrite through the nitritation, and sewage in which ammonia nitrogen and nitrite are mixed at a ratio of 1:0.5 to 1:1.5 may be used for an ANAMMOX. In this example, nitrite does not need to be supplied using separate recycle water.

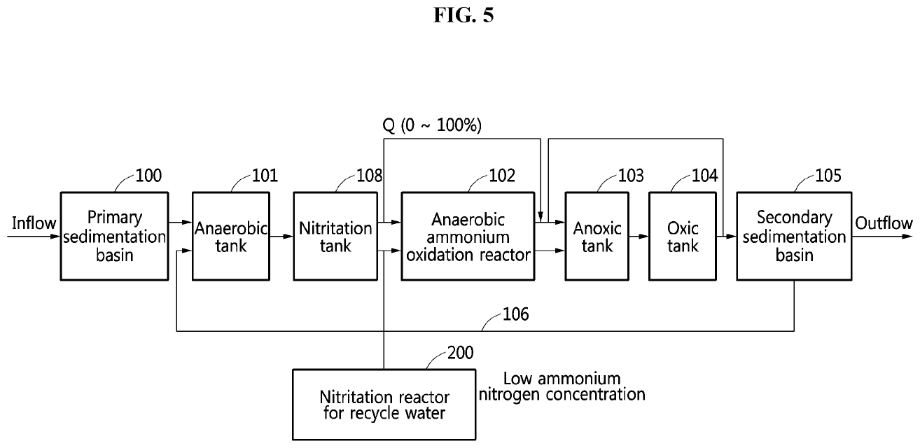

For example, the wastewater treatment system may further include a nitritation reactor 200 for recycle water configured to oxidize ammonia nitrogen in recycle water to nitrite. Effluent from the nitritation reactor for recycle water may flow into the ANAMMOX reactor 102. When a load of nitrite that may be supplied through recycle water is less than an amount of nitrite required for the ANAMMOX, the nitritation reactor 200 may be installed to convert a portion of ammonia nitrogen contained in influent sewage to nitrite, as shown in FIG. 5.

To induce a nitritation of recycle water, through an artificial operation, domination of ammonium oxidizing bacteria (AOB) may need to be induced, and a population and activity of nitrite oxidizing bacteria (NOB) may need to be inhibited. Two methods of inducing a nitritation reaction of recycle water may be provided.

First, a difference in a growth rate between AOB and NOB may be used to induce domination of AOB through NOB wash-out. A growth rate of AOB may be greater about at least twice than a growth rate of NOB at a predetermined temperature or higher (for example, about 30° C. or higher). Thus, a relatively short solid retention time (SRT), for example, about 1 day or 2 days, may be set, to wash out NOB.

Second, an accumulation of nitrite may be induced by an adjustment of free ammonia (FA) and free nitrous acid (FNA). The FA and the FNA may be expressed by a function of a temperature, a pH, ammonia nitrogen and nitrite. For example, when FA has a concentration of 1.0 mg/L to 150 mg/L, and when FNA has a concentration of 2.8 mg/L or less, NOB may be inhibited, and a nitritation may be induced. Generally, in a nitrification, a pH of 7 to 8, a temperature of 30° C. to 35° C., and a concentration of ammonia nitrogen of 150 mg/L or greater may desirably be maintained.

An amount of ammonia nitrogen converted through a nitritation in a nitritation reactor 200 for recycle water may be adjusted to be in a range of 1% to 100% based on a load of ammonia nitrogen in influent sewage.

For example, the wastewater treatment system may further include an anoxic reactor 103 located behind the ANAMMOX reactor 102. In an anoxic reactor, nitrogen oxide generated through the ANAMMOX may be denitrified, and organic matters that still remain in the anaerobic reactor may be removed.

The wastewater treatment system may further include an oxic reactor 104 located behind the anoxic reactor 103. In an oxic reactor, ammonia nitrogen remaining in sewage may be converted to nitrogen oxide, and an organic matter and remaining phosphorus may be removed.

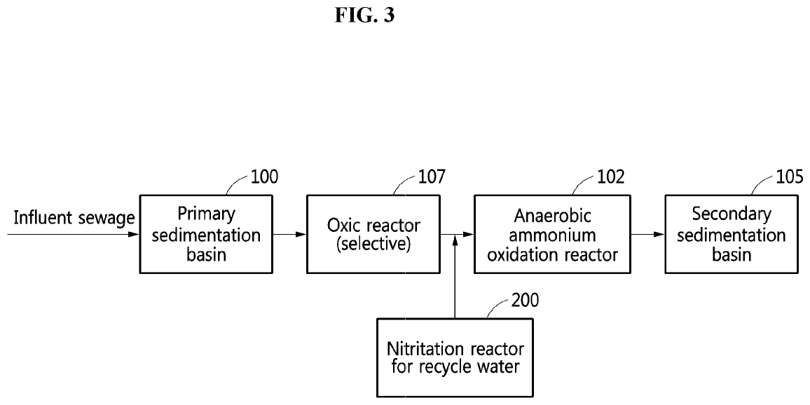

Referring to FIG. 3, the wastewater treatment system may further include an oxic reactor 107 for an organic matter removal process located in front of the ANAMMOX reactor 102. Since an inorganic carbon source is utilized by ANAMMOX bacteria even though an organic matter is removed in the oxic reactor 107, it is possible to obtain an effect of inhibiting an activity of denitrifying bacteria in competition with ANAMMOX bacteria with respect to nitrite, instead of having an influence on the ANAMMOX. However, there is a need to reduce a loss of ammonia nitrogen required for the ANAMMOX by minimizing an oxidization of ammonia nitrogen.

The recycle water may include, for example, but is not limited to, at least one wastewater selected from the group consisting of an anaerobic digestion supernatant, a sludge thickener supernatant and a decanted water, or a combination thereof.

For example, a sludge reduction technology may be applied to the recycle water. When nitrite required for the ANAMMOX is not secured due to a low concentration of ammonia nitrogen contained in the recycle water, a concentration of nitrogen components, such as organic nitrogen and ammonia nitrogen, based on a cell destruction of microorganisms constituting sludge particles may increase using a sludge reduction technology. The sludge reduction technology may include, for example, but are not limited to, ozone, fragmentation, ultrasonic waves, a high temperature digestion, a high temperature aerobic digestion, microbubbles, and the like.

Sewage to which the wastewater treatment system is applied may include, for example, but is not limited to, at least one and more wastewater selected from the group consisting of sewage flowing into a MWTP, a waste supernatant of a sludge process in the sewage treatment plant, a leachate, livestock wastewater excretions and excreta, or a combination thereof.

Hereinafter, the present disclosure will be described in more detail with reference to an example. The following example is given for the purpose of illustrating the present disclosure, and the scope of the present disclosure is not limited thereto.

### EXAMPLE 1

1. Primary Sedimentation Process

Sewage of a municipal wastewater treatment plant was allowed to flow into a primary sedimentation basin, and suspended solid materials in the sewage were precipitated and discharged to an anaerobic reactor.
2. Anaerobic Process

Phosphorus (P) was discharged by phosphorus accumulating organisms (PAOs), and organic matters contained in effluent of the primary sedimentation basin were removed.
3. Recycle Water-Nitritation Process

Based on a concentration of nitrogen contained in recycle water, an additional sludge reduction technology may be applied. For an ANAMMOX process, ammonia nitrogen contained in the recycle water was converted to nitrite, to be allowed to flow into an ANAMMOX reactor. For a nitritation, a method of inhibiting activity of nitrite oxidizing bacteria (NOB) and inducing domination of ammonium oxidizing bacteria (AOB) by adjusting free ammonia (FA) and free nitrous acid (FNA) was used. Under a pH of 7 to 8 and a temperature of 30° C. to 35° C., an FA concentration ranged from 1.0 mg/L to 150 mg/L, an FNA concentration was 2.8 mg/L or less, and ammonia nitrogen of a nitritation reactor for recycle water was maintained over a concentration of 150 mg/L.
4. ANAMMOX Process

Effluent from the anaerobic reactor, together with effluent from the nitritation reactor for recycle water, were allowed to flow into the ANAMMOX reactor. When the effluent from the anaerobic reactor and the effluent from the nitritation reactor for recycle water are mixed, a ratio of ammonia nitrogen and nitrite contained in a mixture was in a range of 1:0.5 to 1:1.5.

A quantity of sewage (Q) flowing into an anoxic reactor, instead of flowing into an ANAMMOX reactor, was determined based on a concentration of nitrite in used recycle water.

Nitrogen contained in sewage was removed using ANAMMOX bacteria in the ANAMMOX reactor.
5. Anoxic Process

Nitrogen oxide generated through the ANAMMOX was denitrified, and organic matters that still remain in the anaerobic reactor were removed.
6. Oxic Process

Ammonia nitrogen contained in sewage flowing from the anaerobic reactor into an oxic reactor through the anoxic reactor was converted to nitrogen oxide, and remaining phosphorous and organic matters contained in sewage flowing out from the anoxic reactor were removed.
7. Secondary Sedimentation Process

The remaining nitrogen oxide was denitrified in the secondary sedimentation basin, and the sewage was returned to the anaerobic reactor through a return line, to further remove phosphorus by a luxury uptake.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A wastewater treatment system comprising:
an ANAMMOX reactor of a water treatment process (mainstream treatment process) into which sewage containing ammonia nitrogen flows; and
a nitritation reactor for recycle water configured to oxidize ammonia nitrogen in wastewater generated in a sludge treatment process to nitrite,
wherein recycle water flowing out from the nitritation reactor for recycle water flows into the ANAMMOX reactor of the water treatment process.

2. A wastewater treatment system comprising:
a primary sedimentation basin configured to deposit sediments in response to an inflow of sewage;
an anaerobic reactor configured to discharge phosphorus contained in effluent of the primary sedimentation basin;
an ANAMMOX reactor configured to remove ammonia nitrogen contained in effluent of the anaerobic reactor using an ANAMMOX; and
a nitritation reactor for recycle water configured to oxidize ammonia nitrogen in recycle water to nitrite,
wherein effluent from the nitritation reactor for recycle water flows into the ANAMMOX reactor.

3. A wastewater treatment system comprising:
a primary sedimentation basin configured to deposit sediments in response to an inflow of sewage;
an anaerobic reactor configured to discharge phosphorus contained in effluent of the primary sedimentation basin;
a nitritation reactor configured to convert ammonia nitrogen contained in a supernatant of the primary sedimentation basin to nitrite; and
an ammonium oxidation reactor configured to remove ammonia nitrogen contained in effluent of the nitritation reactor.

4. The wastewater treatment system of claim 3, further comprising:
a nitritation reactor for recycle water configured to oxidize ammonia nitrogen in recycle water to nitrite,
wherein effluent from the nitritation reactor for recycle water flows into the ANAMMOX reactor.

5. The wastewater treatment system of claim 1, further comprising: an anoxic reactor located behind the ANAMMOX reactor.

6. The wastewater treatment system of claim 5, further comprising: an oxic reactor located behind the anoxic reactor.

7. The wastewater treatment system of claim 1, further comprising: an oxic reactor for an organic matter removal process located in front of the ANAMMOX reactor.

8. The wastewater treatment system of claim 1, wherein the recycle water comprises at least one wastewater selected from the group consisting of an anaerobic digestion supernatant, a sludge thickener supernatant and a decanted water, or a combination thereof

9. The wastewater treatment system of claim 1, wherein a sludge reduction technology is applied to the recycle water.

10. The wastewater treatment system of claim 1, wherein the sewage comprises at least one or more wastewater selected from the group consisting of sewage flowing into a municipal wastewater treatment plant, a recycle water in the municipal wastewater treatment plant, a leachate, livestock wastewater and excreta, or a combination thereof.
